(19) United States
(12) Patent Application Publication
(10) Pub. No.: US 2005/0152553 A1
(43) Pub. Date: Jul. 14, 2005

(54) Method of synchronizing dynamic decryption keys and matching content protected data in a real time environment

(76) Inventors: Takuya Kosugi, San Diego, CA (US); Shyh-Jye Anthony Chen, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/799,402

(22) Filed: Mar. 12, 2004

Related U.S. Application Data
(60) Provisional application No. 60/536,359, filed on Jan. 14, 2004.

(51) Int. Cl. H04K 1/00

(52) U.S. Cl. 380/286

(57) ABSTRACT

According to one embodiment of the invention, feeder logic is implemented as a software program stored in a machine readable medium and executed by a processor. The feeder logic is adapted to access indexing data associated with a pre-stored data unit. The pre-stored data unit including content in a scrambled format. The feeder logic is further adapted to generate a trigger data sequence and to insert the trigger data sequence into a data stream processed by a descrambler in response to detection that the content in the scrambled format cannot be descrambled by the descrambler using a currently valid descrambling key. The trigger data sequence is inserted prior to scrambled content of the pre-stored data unit to be processed.

### CROSS-REFERENCE TO RELATED APPLICATIONS

This application is based on a U.S. Provisional Patent Application No. 60/536,359, filed on Jan. 14, 2004.

### BACKGROUND

1. Field

Embodiments of the invention relate to the field of descrambling. More specifically, one embodiment of the invention relates to a system, apparatus and method for real-time synchronization between incoming scrambled content and the keying material used for descrambling the scrambled content.

2. General Background

Over the last decade, there have been significant advances in content recording devices. Digital recording devices are starting to replace legacy analog recording devices such as videocassette recorders (VCRs). The impetus for these advances revolves around the current movement towards digital communications, namely the transmission of content in a digital form. A hard disk-based recorder is but merely representative of the types of digital recording devices that is capable of producing high quality recordings, without the generational degradation (i.e., increased degradation between successive copies) known in the analog recording counterparts.

The movement towards digital communications and advancements in digital recording devices has caused reluctance by content providers, such as the motion picture and music industries for example, in providing downloadable digital content. Such reluctance is based on fears of unauthorized and uncontrolled copying of their digital content. As a result, prior to broadcast, digital content is often scrambled using periodically updated keys. In order to seamlessly descramble the scrambled digital content at the receiver side, the descrambling keys must be updated the same general periodicity as performed at the broadcast station. The period that a key is valid is referred to a “crypt period”.

For instance, in a digital broadcast system, a targeted digital device features a descrambler that receives an incoming data stream including scrambled digital content. The descrambler performs key alternation using two different key slots, namely an “Even” key slot and an “Odd” key slot.

More specifically, each key slot is loaded with a descrambling key and the descrambling keys associated with the key slots are alternatively accessed to descramble incoming content. As an example, during a first crypt period, a first descrambling key associated with the Even key slot (Even key #1) is accessed for descrambling purposes. At the next crypt period, a second descrambling key associated the Odd key slot (Odd key #1) is accessed for use by the descrambler. At the next crypt period, a substitute key (Even key #2) for the first descrambling key placed in the Even key slot (hereinafter referred to as an “updated descrambling key”), is accessed, and so on.

The above-described conventional key alternation process is accomplished by alternatively updating descrambling keys within either the Even key slot or the Odd key slot for use by the descrambler. This alternation process is accomplished using a slot selection flag and information within an entitlement control message (ECM).

Embedded in an incoming stream of content (hereinafter referred to as a “content stream”), the slot selection flag signals the descrambler as to which descrambling key within a selected key slot needs to be updated. Normally, the slot selection flag identifies the key slot that is not accessed during the current crypt period.

The Entitlement Control Message (ECM) is a control message that is demultiplexed from the content stream. Information contained within the ECM is used to produce the updated descrambling key. Hence, the ECM is provided well in advance of the content scrambled with the updated descrambling key to ensure seamless processing by the descrambler.

Hence, as long as a newly updated descrambling key is associated with an alternative key slot not being used during the current crypt period, the content can be seamlessly descrambled. While this key alternation process is suitable for descrambling broadcast, scrambled content, it does not function in a seamless manner when the scrambled content is recovered from a digital recording device for viewing.

Most digital recording devices feature a “trick play” mode, which is a transport control that allows an end user to navigate to different portions of the recorded content. Examples of certain controls during the trick play mode include Fast Forward, Instant Replay, etc. Such navigation may involve jumping between non-sequential content. As a result, the desired content may be scrambled with descrambling keys located in the same key slot.

For example, the end user may select a video frame scrambled with Even key #1, then select a video frame scrambled with Even key #8. In these types of situations, the descrambling of the stored digital content will not be seamless. Instead, the descrambling keys to descramble the non-sequential data frames are computed without sufficient lead time to avoid stalling the descrambler. This causes a pause that is visible to the end user.

### BRIEF DESCRIPTION OF THE DRAWINGS

Embodiments of the invention are illustrated by way of example and not by way of limitation in the accompanying drawings, in which like references indicate similar elements and in which:

FIG. 1 is an exemplary embodiment of a secure content delivery system including a digital device;

FIG. 2 is an exemplary embodiment of the digital device associated with the secure content delivery system of FIG. 1;

FIG. 3 is an exemplary embodiment of operations performed by recorder logic and feeder logic controlled by a processor of the digital device of FIG. 2;

FIG. 4 is a more detailed illustration of an index table located at the hard disk drive (HDD) of FIG. 2;

FIG. 5 is an exemplary embodiment of a data flow by the digital device under logic control;

FIG. 6 is an exemplary embodiment of the incoming content stream received for processing by the recording logic of FIG. 3;

FIG. 7 is an exemplary embodiment of the retrieval of content along with at least a portion of the indexing data and insertion of a trigger data sequence as needed by the feeder logic;

FIG. 8 is a first exemplary embodiment of a trigger data sequence;

FIG. 9 is a second exemplary embodiment of a trigger data sequence;

FIG. 10 is a third exemplary embodiment of a trigger data sequence; and

FIG. 11 is an exemplary embodiment of a flowchart of the operations of the digital device to synchronize the loading of the descrambling keys and the stream of scrambled content data in real time.

### DETAILED DESCRIPTION

Various embodiments of the invention relate to a system, apparatus and method for synchronizing between the feed of a descrambling key and its corresponding scrambled content. According to one embodiment of the invention, this may be accomplished by automatically updating the descrambling key in response to detection of an artificially inserted trigger data sequence. This key update is performed in real-time without stalling the descrambler to fetch a new descrambling key. As a result, the descrambler can seamlessly descramble incoming scrambled content, even if the content is non-sequential and scrambled with different keys associated with the same key slot.

In the following description, certain terminology is used to describe features of the invention. For instance, the terms “logic” or “logic element” generally denotes hardware and/or software configured to perform one or more functions. Examples of “hardware” include, but are not limited or restricted to an integrated circuit such as a processor (e.g., microprocessor, application specific integrated circuit, a digital signal processor, a microcontroller, etc.), a finite state machine, combinatorial logic, a programmable logic device (e.g., field programmable gate array, etc.), or the like.

An example of “software” includes a series of executable instructions (e.g., module) in the form of an application, an applet, microcode, or even a routine. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory), a floppy diskette, an optical disk (e.g., compact disk or digital video disc “DVD”), a hard drive disk, tape, or the like.

Additional terminology and varying tenses thereof may be used to describe other features of the invention. For example, the term “keying material” is generally defined as information used as a key, to generate a key or to recover a key. Examples of keying material include, without limitation, (1) a seed value used to generate a key or recover a pre-stored key, and (2) a key itself (or portion thereof). The term “descrambling” is generally defined as an operation of converting content from an obfuscated format into a clear format that can be perceived (e.g., viewed and/or listened) by an end user.

The term “content” is generally defined as data formed by one or more data units (e.g., packets, frames, etc.). These content may be video, audio, or any other data type such as an image, a file, a document including alphanumeric text, a web page or the like.

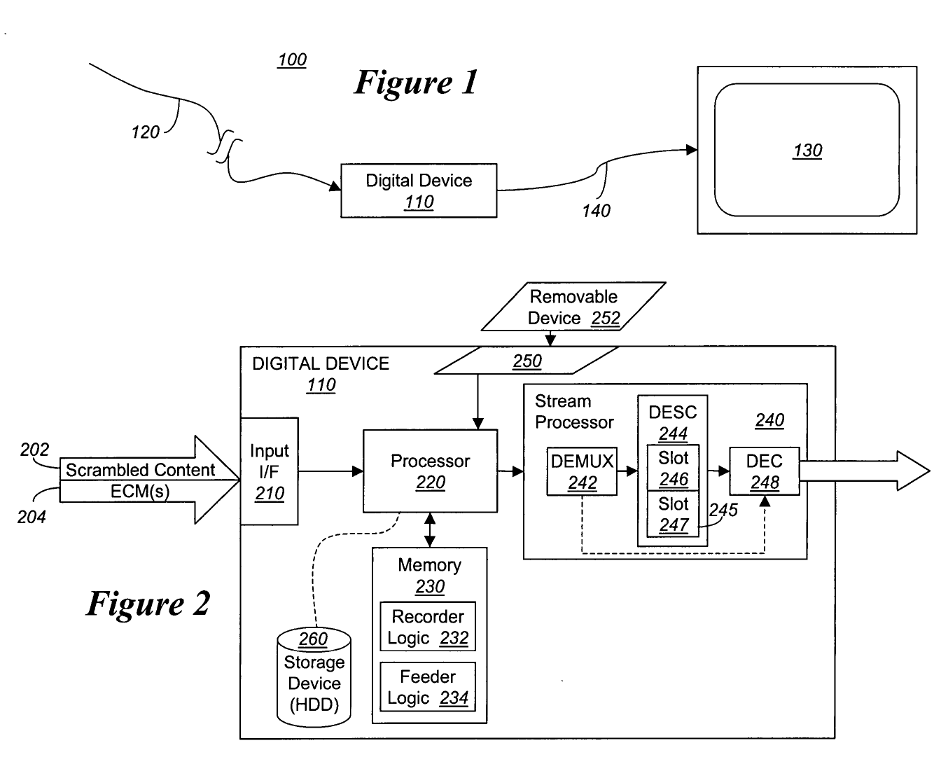

Referring to FIG. 1, an exemplary embodiment of a secure content delivery system 100 is shown. Content delivery system 100 includes a digital device 110 that receives content from one or more content providers via a first transmission medium 120. The content is propagated as part of a bit stream, namely a series of digital bits in succession with address and/or control information (hereinafter referred to as “content stream”). Digital device 110 may operate as any of a wide variety of products, including one or more of the following: a digital recording device such as a digital versatile disk (DVD) recorder, digital VHS video cassette recorder (D-VHS VCR), CD-ROM recorder (e.g., CD-R and CD-RW), MP3 recorder, or hard disk-based (HDD) recorder; a set-top box; a digital satellite receiver; a television; a cellular telephone; or a computer. Of course, other products may be adapted to deploy the invention as claimed.

As shown, when implemented as a digital recording device, digital device 110 may be coupled to a playback device 130 (e.g., television, audio receiver and/or speakers, a monitor, etc.) via a second transmission medium 140. Transmission mediums 120 and 140 operate to transmit an incoming content stream to digital device 110 and from digital device 110 to playback device 130, respectively. “Transmission medium” 120 and 140 may include, but is not limited to electrical wires, optical fiber, cable, a wireless link established by wireless signaling circuitry, or the like.

Referring now to FIG. 2, a first exemplary embodiment of digital device 110 associated with content delivery system 100 of FIG. 1 is shown. Herein, digital device 110 comprises an interface 210, a processor 220, a memory 230, a stream processor 240, an optional interface 250 and an optional storage device 260.

As shown, interface 210 is adapted to receive incoming content stream 200, including scrambled content 202. Scrambled content 202 comprises one or more (N) data units (e.g., video, audio, etc.) that are scrambled with periodically altered keys. According to one embodiment of the invention, scrambled content 202 is multiplexed with one or more ECMs 204 associated therewith. The ECMs 204 provides keying material for use in descrambling scrambled content 202.

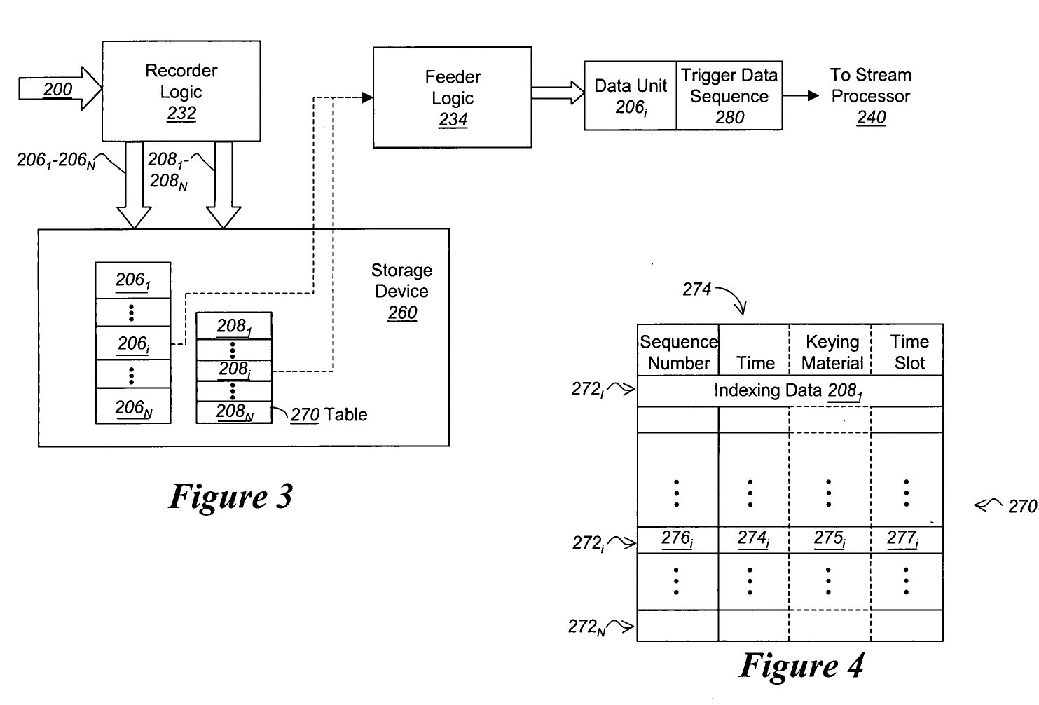

According to one embodiment of the invention, as shown collectively in FIGS. 2 and 3, memory 230 is loaded with recorder logic 232 and feeder logic 234, namely software that is executed by processor 220 for this embodiment of the invention. As shown, memory 230 is deployed external to processor 220 as non-volatile memory (e.g., flash, read only memory, battery-backed random access memory, etc.). Of course, it is contemplated that memory 230 may be implemented as on-chip memory or may be situated internally within a semiconductor package as part of a multi-chip processor module.

As shown in detail in FIG. 3, recorder logic 232 is adapted to parse incoming content stream 200 into N separate data units 206₁-206_{N} (N≧1), each having data in a scrambled format. Recorder logic 232 is further adapted to extract information from each data unit 206₁-206_{N} as metadata, namely data that preserves the relationship between each data unit 206₁-206_{N} and the keying material associated therewith. According to one embodiment of the invention, the metadata (hereinafter referred to as “indexing data” 208₁-208_{N}) identifies certain attributes of the corresponding data units 206₁-206_{N}. These attributes include, but are not limited or restricted to the following: (1) a sequence number assigned to the data unit; (2) a transmission (broadcast) time for the data unit; (3) keying material associated with the data unit; (4) a key slot number to which its descrambling key resides, and the like.

Thereafter, recorder logic 232 begins the transfer of data units 206₁-206_{N} and indexing data 208₁-208_{N} into storage device 260.

As shown in detail in FIG. 2, storage device 260 is located within digital device 110 and is deployed as a hard-disk drive (HDD). It is contemplated, however, that storage device 260 may be deployed external to digital device 110 or as another type of readable machine medium. Storage device 260 stores an index table 270 along with data unit 206₁-206_{N} in a storage location separate from index table 270.

As shown in FIG. 4, index table 270 is segregated into a plurality of entries 272₁-272_{N}, which entry associated with indexing data 208₁, . . . , or 2068_{N} associated with a particular data units 206₁-206_{N}. It is contemplated that one or more attribute from indexing data 208₁-208_{N} may be used in locating its corresponding data unit 206₁-206_{N}, respectively.

Referring back to FIGS. 2 and 3, feeder logic 234 is implemented with software modules perform the operations described below. Herein, feeder logic 234 accesses indexing data 208ᵢ associated with a targeted data unit stored in storage device 260 (e.g., data unit 206ᵢ, where 1≦i≦N). Based on information stored within indexing data 208ᵢ associated with data unit 206ᵢ, feeder logic 234 is able to determine whether the current key value (“Current_Key”) and the key value needed for descrambling scrambled content contained in data unit 206ᵢ (“Future_Key”) are different as well as to locate data unit 206ᵢ.

The key value comparison may be accomplished through a number of techniques. For instance, where keying material is used as a descrambling key, Current_Key is merely compared to the accessed keying material. However, where keying material is used to generate or recover a descrambling key, the accessed keying material is compared to the keying material used to generate or recover Current_Key.

Of course, in lieu of comparison of the entire keying material, it is contemplated that the comparison may be conducted between a portion of the accessed keying material and a portion of Current_Key or the keying material used to produce Current_Key. While these are a few of the possible comparison techniques described for illustrative purposes only, it is contemplated that other comparison techniques may be utilized.

Upon determining that Current_Key and Future_Key are different, feeder logic 206ᵢ inserts a trigger data sequence 280 prior to recovered data unit 206ᵢ (i.e., prior to where the descrambling key changes). Trigger data sequence 280 provides information to stream processor 240 to indicate that an updated descrambling key is needed to descramble the scrambled content contained within data unit 206ᵢ.

As an optional feature, interface 250 may be adapted as an expansion slot to receive a removable device 252, which is complementary to interface 250. For this embodiment, interface 250 is a smart card interface adapted for attachment to a smart card. Of course, interface 250 may be configured to support other form factors besides a smart card, such as a CableCard having a PCMCIA interface format.

According to one embodiment of the invention, keying material accessed by feeder logic 234 may be provided to removable device 252 if an updated descrambling key is required. Based on the accessed keying material, removable device 252 generates at least one updated descrambling key for descrambling the scrambled content associated with the targeted data unit. The updated descrambling key may be provided to stream processor 240 for insertion into an appropriate key slot or provided to feeder logic 234 for insertion into trigger data sequence 280 itself. Of course, the keying material and/or the descrambling keys may be encrypted during transmissions with removable device 252 if such security is desired.

Referring to FIG. 2, stream processor 240 is responsible for the descrambling of content placed in a scrambled format for transmission to digital device 110. According to one embodiment of the invention, stream processor 240 comprises a demultiplexer 242, a descrambler 244, and a decoder 248. In general, demultiplexer 242, descrambler 244 and decoder 248 collectively operate to convert content from an obfuscated format into a clear format that can be perceived by an end user. Moreover, any of these logic elements may be configured to detect a trigger data sequence, and in response, to automatically update the descrambling key in real-time without stalling stream processor 240.

According to one embodiment of the invention, demultiplexer 242 is adapted to separate the scrambled content of each incoming data unit from other types of information. Moreover, demultiplexer 242 may be adapted to detect a trigger data sequence and to extract commands used to adjust the operations of stream processor 240. For instance, demultiplexer 242 may be adapted to route commands to decoder 248 to alter its functionality (e.g., select a specific decryption algorithm, etc.). Likewise, demultiplexer 242 is adapted to route commands to descrambler 244 to alter its functionality.

Descrambler 244 is adapted to descramble the scrambled content using descrambling keys stored in internal memory 245. An example of internal memory 245 includes one or more registers forming an Even key slot 246 and/or Odd key slot 247. In response to detection of a trigger data sequence, descrambler 244 is configured to use information provided by the trigger data sequence to obtain the updated descrambling key. For instance, the key material may be used to generate the updated descrambling key. Alternatively, the key material may be used as an index value to recover the updated descrambling key from non-volatile memory placed within descrambler 244 or within stream processor 240. Alternatively, the key material may be placed directly into a key slot identified by trigger data sequence.

Decoder 248 is used to decode the descrambled content if the content is also encoded. One type of decoding involves decryption.

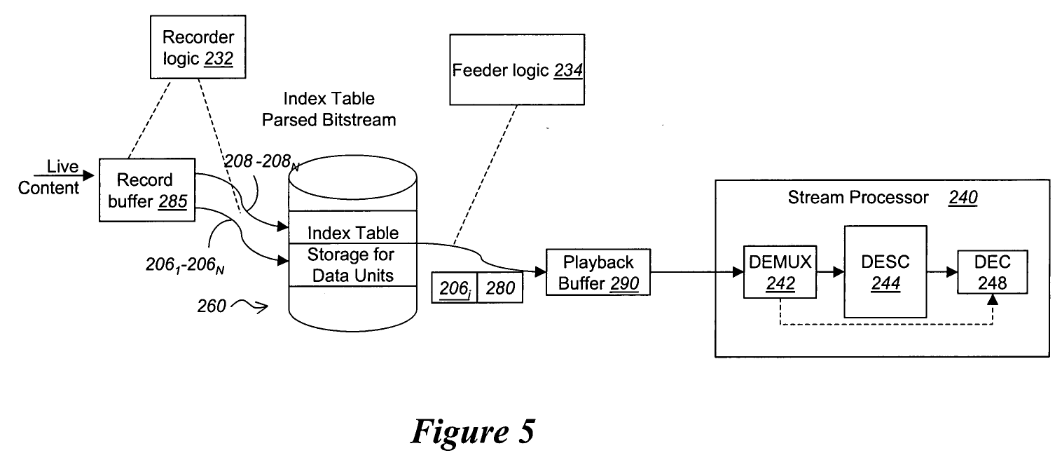

Referring to FIG. 5, an exemplary embodiment of a data flow under control by recorder logic 232 and feeder logic 234 of digital device 110 is shown. Herein, recorder logic 232 parses received content, temporarily stored in a record buffer 285, into N separate data units 206₁-206_{N}, each having data in a scrambled format. Furthermore, recorder logic 232 extracts indexing data 208₁-208_{N} associated with data units 206₁-206_{N}.

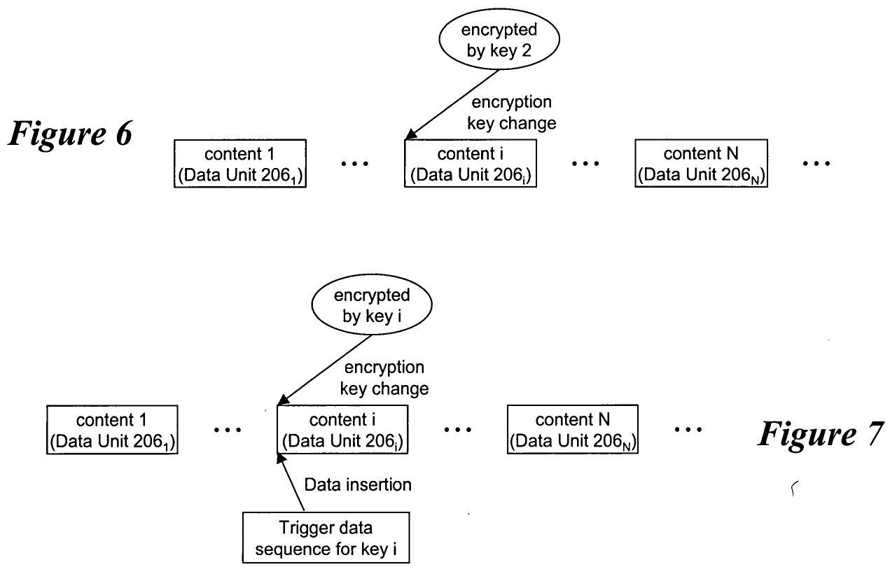

Thereafter, data units 206₁-206_{N} along with their indexing data 208₁-208_{N} (collectively referred to as “Content1-ContentN”) are stored within storage device 260 (see FIG. 6). More specifically, as described above, recorder logic 232 loads indexing data 208₁-208_{N} into index table 270 stored in storage device 260. Recorder logic 232 also loads scrambled data units 206₁-206_{N} into storage device 260.

When recorded, scrambled content associated with a particular data unit (e.g., data unit 206₁) is requested for playback, feeder logic 234 accesses indexing data 208₁ associated with scrambled data unit 206₁ and recovers the scrambled content associated with data unit 206₁ for playback. For example, a user requests playback of a previously aired and digitally recorded television program and begins watching the television program. Thereafter, end user causes the digital device to enter into a “trick play” mode to navigate to a different segment of the recorded content (e.g., data unit 206ᵢ).

In response, feeder logic 234 accesses the broadcast time parameters 274 stored in index table 270 until a broadcast time parameter 274ᵢ associated with data unit 206ᵢ is detected. As a result, feeder logic 234 retreives keying material 275ᵢ to determine whether the descrambling key currently used differs from a key value needed to descramble scrambled content contained in data unit 206ᵢ. Also, feeder logic 234 accesses retrieves a corresponding sequence number 276ᵢ for data unit 206ᵢ. Sequence number 276ᵢ is used by feeder logic 234 to subsequently locate and retrieve data unit 206ᵢ within storage device 260.

In the event that the descrambling key currently used differs from a key value needed to descramble scrambled content contained in data unit 206ᵢ, feeder logic 234 produces trigger data sequence 280 and inserts trigger data sequence 280 prior to data unit 206ᵢ as shown in FIG. 7. Therefore, feeder logic 234 temporarily loads this resultant stream of information into a playback buffer 290.

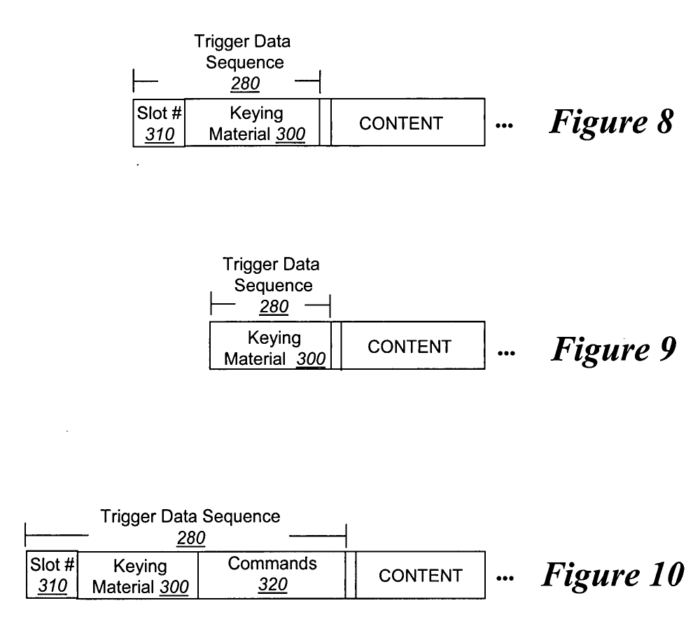

Referring now to FIG. 8, a first exemplary embodiment of a trigger data sequence 280 of FIG. 7 is shown. Herein, trigger data sequence 280 comprises keying material 400 and a slot number 410. Keying material 400 operates either as the updated descrambling key or as a value to produce or recover the updated descrambling key. Slot number 410 identifies which key slot is targeted to receive the updated descrambling key.

Referring now to FIG. 9, a second exemplary embodiment of trigger data sequence 280 of FIG. 7 is shown. Herein, trigger data sequence 280 solely comprises keying material 400. This implementation is possible when descrambler 244 is implemented with a single key slot.

Referring to FIG. 10, a third exemplary embodiment of trigger data sequence 280 of FIG. 7 is shown. Herein, trigger data sequence 280 comprises keying material 400, slot number 410 and a command field 420, which adjusts the operations of descrambler 244. For instance, command field 320 may specific a particular descrambler mode such as what decode function is to be performed (e.g., DES, 3DES, AES, etc.). Command field 420 may be used to adjust the descrambler speed.

Referring back to FIG. 5, once descrambler 244 becomes aware of the presence of triggered data sequence 280, descrambler 244 parses triggered data sequence 280 to obtain or decide what key to use and automatically change its settings appropriately to descramble incoming scrambled content associated with data unit 206ᵢ.

For example, where the keying material constitutes the updated descrambling key, descrambler 244 loads the keying material into an appropriate key slot identified by trigger data sequence 280. As another example, descrambler 244 uses keying material 274ᵢ as an index to fetch descrambling keys pre-loaded into non-volatile memory within descrambler 244 or securely accessible by descrambler. These descrambling keys may be pre-loaded during manufacture of the stream processor 240 (or descrambler 244 itself if a separate integrated circuit), during manufacture of the digital device, or downloaded in a secure manner from the content provider via a broadcast or unicast control message.

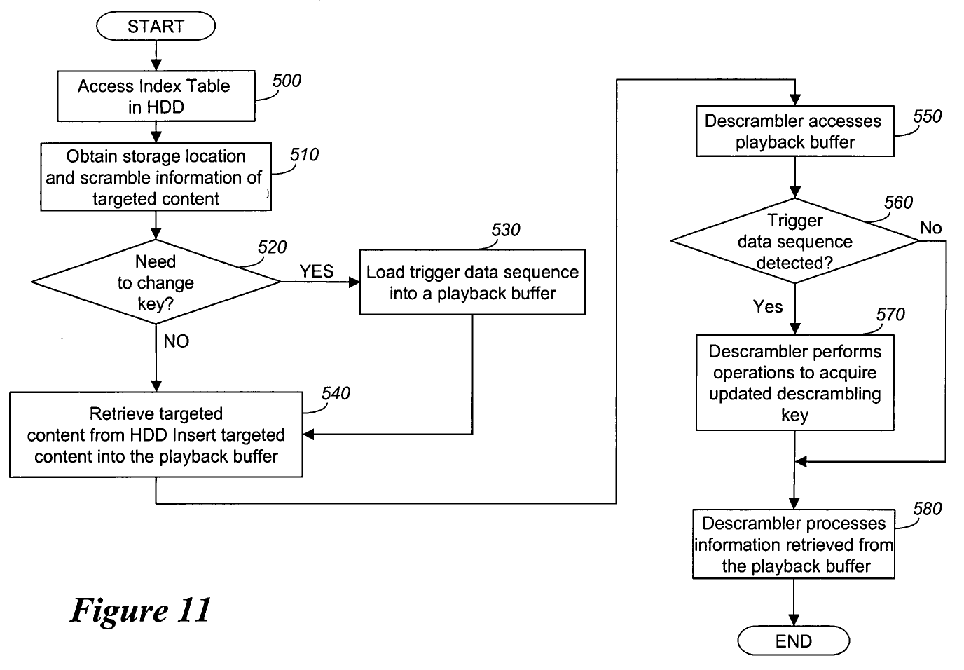

Referring now to FIG. 11, an exemplary embodiment of a flowchart of the operations of the digital device to synchronize the loading of the descrambling keys and the stream of scrambled content data in real time is shown. First, an index table is accessed in a storage device (e.g., HDD) to retrieve indexing data for a specific data unit to be descrambled for viewing or playback (block 500). The specific data unit is located in the storage device, perhaps through use of a parameter of the indexing data associated with that data unit, and retrieved (blocks 510 and 520).

Next, a decision is made whether the descrambling key currently be used is capable of descrambling the retrieved data unit (block 530). If the current descrambling key cannot be used to descramble the retrieved data unit, a trigger data sequence is loaded into a temporary buffer prior to the retrieved data unit (block 540). Otherwise, the retrieved data unit is merely loaded into the temporary buffer (block 550).

During its descrambling operations, descrambler accesses the playback buffer to obtain the retrieved data unit (block 560). If a trigger data sequence is detected, descrambler recognizes that the following data unit will need to be descrambled using an updated descrambling key (block 570). The updated descrambling key may be obtained through extraction of the keying material from the trigger data sequence, or using the keying material as a seed value to produce or recover the updated descrambling key in real-time. This technique synchronizing the updated descrambling keys with associated content. Otherwise, the descrambler descrambles the incoming scrambled content using the current descrambling key. For either condition, descrambler processes the retrieved information, namely the data unit having content scrambled with the updated descrambling key (block 580).

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are accordingly to be regarded in an illustrative rather than in a restrictive sense.

1. A method comprising:
accessing indexing data associated with a data unit previously stored within a storage device, the data unit including content in a scrambled format;
using at least a portion of the indexing data, determining whether the content in the scrambled format is capable of being descrambled by a descrambler using a currently valid descrambling key;
retrieving the data unit; and
forming a data stream for processing by the descrambler, the data stream including a trigger data sequence inserted prior to the data unit, the trigger data sequence to identify that the data unit is capable of being descrambled by the descrambler using an updated descrambling key differing from the currently valid descrambling key.

2. The method of claim 1, wherein accessing of the indexing data comprises accessing keying material associated with the data unit from a table stored within the storage device.

3. The method of claim 2, wherein the determining whether the content in the scrambled format is capable of being descrambled by the descrambler using the currently valid descrambling key comprises comparing the keying material with a keying material used to produce the current valid descrambling key.

4. The method of claim 3, wherein the determining whether the content in the scrambled format is capable of being descrambled by the descrambler using the currently valid descrambling key comprises comparing the keying material with the current valid descrambling key.

5. The method of claim 1, wherein the data unit is non-sequential in time to a current data unit being descrambled by the descrambler using the currently valid descrambling key.

6. The method of claim 1, wherein the trigger data sequence includes keying material and a slot number.

7. The method of claim 1, wherein the trigger data sequence includes keying material, a slot number and at least one command code to alter functionality of the descrambler.

8. The method of claim 1 further comprising:
inputting the data stream into a playback buffer;
retrieving the data stream by the descrambler; and
in response to detection of the trigger data sequence, obtaining the updated descrambling key using information contained within the trigger data sequence.

9. The method of claim 8, wherein the obtaining of the updated descrambling key comprises using keying material contained in the trigger data sequence to recover a decrambling key pre-stored within a non-volatile memory accessible to the descrambler.

10. A software program stored in a machine readable medium and executed by a processor, the software program comprising:
a first module to access indexing data associated with a pre-stored data unit, the pre-stored data unit including content in a scrambled format; and
a second module to generate a trigger data sequence and insert the trigger data sequence into a data stream processed by a descrambler prior to the pre-stored data unit in response to detection that the content in the scrambled format cannot be descrambled by the descrambler using a currently valid descrambling key.

11. The software program of claim 10, wherein the indexing data comprises keying material associated with the pre-stored data unit from a table stored within a hard disk drive.

12. The software program of claim 10, wherein the pre-stored data unit is non-sequential in time to a current data unit being descrambled by the descrambler using the currently valid descrambling key.

13. The software program of claim 10, wherein the trigger data sequence includes keying material and a slot number.

14. The software program of claim 10, wherein the trigger data sequence includes keying material, a slot number and at least one command code to alter functionality of the descrambler.

15. A digital device, comprising:
a storage device adapted to store content received from a transmission and metadata associated with the content, the content includes a video program in a scrambled format;
a descrambler adapted to descramble incoming content using a descrambling key stored in any one of a plurality of key slots accessible by the descrambler; and
a host processor in communication with the storage device and the descrambler, the host processor to access the metadata data and to generate a trigger data sequence for insertion into a data stream prior to video program in response to detection that the video program is capable of being descrambled only by an updated descrambling key being different than descrambling keys currently stored in the plurality of key slots.

16. The digital device of claim 15, wherein the trigger data sequence includes keying material associated with the video program and a slot number identifying which of the plurality of key slots the updated descrambling key is assigned.

17. The digital device of claim 15, wherein the trigger data sequence includes keying material associated with the video program, a slot number identifying which of the plurality of key slots the updated descrambling key is assigned, and at least one command code to alter functionality of the descrambler.
